(19) United States
(12) Patent Application Publication
(10) Pub. No.: US 2016/0273569 A1
(43) Pub. Date: Sep. 22, 2016

(54) Plug

(71) Applicant: Robert Bosch GmbH, Stuttgart (DE)

(72) Inventors: Simone Bosatelli, Stuttgart (DE); Dominic Winkler, Shanghai (CN); Felix Schuler, Solothurn (CH)

(21) Appl. No.: 15/070,867

(22) Filed: Mar. 15, 2016

(30) Foreign Application Priority Data
Mar. 17, 2015 (DE) 10 2015 204 762.8

(51) Int. Cl. F16B 13/00; F16B 13/06

(52) U.S. Cl. CPC F16B 13/002; F16B 13/06

(57) ABSTRACT

A plug configured to be fastened in a workpiece, in particular a drilled hole of a workpiece that can be, for example, wood, metal, plastic, stone, or composite, includes a hollow body that has at least one expansion arm and an expansion element. The expansion arm is configured to connect to the workpiece in at least one of a form fitting and force-fitting manner. The expansion element is configured to expand the at least one expansion arm, particularly at least substantially radially. The plug, in particular the expansion arm, further includes at least one cutting element configured to cut into the workpiece.

This application claims priority under 35 U.S.C. §119 to patent application no. DE 10 2015 204 762.8, filed on Mar. 17, 2015 in Germany, the disclosure of which is incorporated herein by reference in its entirety.

The disclosure relates to a plug, in particular an anchor, for fastening in a workpiece, in particular in a drilled hole of a workpiece, in particular of wood, metal, plastic, stone or a composite, having a, in particular at least substantially sleeve-type, hollow body having at least one expansion arm for connecting to the workpiece, in particular in a form-fitting and/or force-fitting manner, and having an expansion element for expanding, at least substantially radially, the at least one expansion arm of the hollow body.

### BACKGROUND

DE 197 21 857 A1 discloses an expansion anchor, having an expansion cone and having an expansion sleeve, which has forwardly projecting expansion tongues. To enable the expansion anchor to be anchored in masonry in a work operation, the disclosure proposes that the expansion cone and front ends of the expansion tongues be realized with cutting edges. It is thereby possible to make a cylindrical drilled hole in masonry without pre-drilling with an expansion cone and, after a desired depth of the expansion sleeve has been attained, to use the expansion tongues of the latter to expand the expansion cone.

### SUMMARY

The disclosure is based on the object of realizing a plug, by use of simple design means, such that the plug can be rapidly and easily inserted in a workpiece.

The object is achieved with a plug, in particular an anchor, for fastening in a workpiece, in particular in a drilled hole of a workpiece, in particular of wood, metal, plastic, stone or a composite, having a, in particular at least substantially sleeve-type, hollow body having at least one expansion arm for connecting to the workpiece, in particular in a form-fitting and/or force-fitting manner, and having an expansion element for expanding, in particular at least substantially radially, the at least one expansion arm of the hollow body. According to the disclosure, the hollow body, in particular at least one expansion arm of the hollow body, has at least one cutting element for drilling into the workpiece.

The plug according to the disclosure enables the plug to be set into a workpiece, in particular a wall, with a minimized number of work steps and work tools. In this case, in a first work step, a cylindrical drilled hole having a desired depth is drilled into a workpiece by means of the plug and, in a second, or further, work step, the plug is fixed in the drilled hole. In the case of the second work step, the expansion element is driven, or hammered, percussively, in particular axially, against the hollow body by means of, for example, a hammer or a percussive or hammering device of a receiving unit and/or hand-held power tool. As a result, the expansion element can expand the expansion arms, in particular radially, such that a form-fitting and/or force-fitting connection is realized between the expansion arm and the drilled hole. It is possible in this case to dispense with further intermediate work steps used at present, such as, for example, pre-drilling by means of an additional drilling tool, since the pre-drilling can already be achieved by means of the plug, or the hollow body. The plug thus makes it possible for the plug to be inserted in the workpiece in a minimal number of work steps, thereby saving at least one work step. Moreover, advantageously, the torsional load on the plug during drilling is reduced, since a maximum radial extent of the hollow body of the plug corresponds substantially to a maximum radial extent of the drilled hole. The hollow body of the plug can therefore absorb a greater torsional moment.

The plug according to the disclosure is realized in at least two pieces. The plug has a, in particular, substantially sleeve-type hollow body. The hollow body is additionally provided with at least one expansion arm. The expansion arm is provided to produce a, in particular form-fitting and/or force-fitting, connection to the workpiece, in particular to a drilled hole of the workpiece. The plug has an expansion element, which is realized for expanding radially, in particular at least substantially, the at least one expansion arm of the hollow body. According to the disclosure, the hollow body, in particular at least one expansion arm of the hollow body, has at least one cutting element for drilling into the workpiece.

A “cutting element” in this context is to be understood to mean a geometrically defined or undefined element realized for cutting materials. A cutting element in this case may be realized for cutting and/or shaving materials. The cutting element may have at least one edge, in particular a cutting edge. The cutting element may be realized as at least one corner and/or at least one tapering.

In the setting of the plug, in a second work step, the cutting element may be provided to realize a form-fitting and/or force-fitting connection to the drilled hole, or to the workpiece.

The claims specify expedient developments of the plug according to the disclosure.

It may be expedient for the hollow body, in particular at least one expansion arm of the hollow body, to have at least one centering element for centering the plug. This has the effect that, during tapping of the workpiece, the plug does not slip away or drift away and consequently result in tapping at an unintended position on the workpiece.

The centering element in this case may be realized by at least one edge or a point, such as, for example, a corner or tapering realized by at least two edges extending at least partially obliquely in relation to each other. In particular, in this case an end point of an edge may be realized as a centering element. The centering element may be realized so as to be integral with the cutting element, such that at least one cutting edge of a cutting element is formed, at least partially, as a centering element. The centering element may be provided to realize a mid-point, which constitutes the rotation axis of the plug and/or of the hole to be drilled. The centering element in this case may delimit, at least substantially, an axial extent of the plug.

Preferably, at least one expansion arm may have a maximum radial extent that differs from a maximum radial extent of at least one further expansion arm. Preferably, at least one expansion arm may have a maximum axial extent that differs from a maximum axial extent of at least one further expansion arm. Particularly preferably, at least one expansion arm may have a geometry that differs from the geometry of at least one further expansion arm.

In a preferred embodiment, at least one expansion arm of the hollow body may have the at least one cutting element and the at least one centering element, the expansion arm having a maximum radial extent that differs from a maximum radial extent of at least one further expansion arm. The cutting element and the centering element in this case may be realized as a single piece, and thus separate from the at least one expansion arm. The cutting element and the centering element in this case may be connected to at least one expansion arm in a fixed manner such as, for example, by means of a welding method or other method considered appropriate by persons skilled in the art, or in a separable manner such as, for example, by means of a clamping method or other method considered appropriate by persons skilled in the art.

The at least one expansion arm may be realized as a drilling expansion arm. The drilling expansion arm in this case may have at least one cutting element, and be realized to drill the plug into the workpiece. In an alternative embodiment, the plug has one or more drilling expansion arms, which are provided to drill the plug into a workpiece. The drilling expansion arm may extend farther in the circumferential direction than other, or adjacent, expansion arms of the plug. The drilling expansion arm may extend radially from a circumferential region as far as an axis of the plug or farther than the axis of the plug. The drilling expansion arm may be realized so as to be more massive than the other expansion arms of the plug. The drilling expansion arm may be realized in such a manner that expansion of the drilling expansion arm is effected only to a limited extent as the plug is being set.

In one exemplary embodiment, the cutting element may contain a hard metal or be composed thereof. This has the effect that drilling in the material to be drilled progresses reliably and rapidly. Alternatively, it may be advantageous if the cutting element does not contain a hard metal, or is not composed thereof.

Further, the expansion element may be realized, at least substantially, in the form of a cylinder or in the form of a cone. Setting of the plug, in the second work step, can thereby be simplified, advantageously, since the cylinder-type or cone-type expansion element can expand the expansion arms very rapidly and effectively as a result of the percussive motion.

Preferably, the hollow body may have an internal region, in particular at least one internal surface, which extends, in particular at least substantially, in the form of a cone or in the form of a cylinder in relation to an axis. The internal region, in particular the at least one internal surface, in this case may be angled in the direction of advance, in particular tapered. A radial pressing force can thereby be maximized, advantageously, during setting of the plug in the second work step.

In an advantageous embodiment, the hollow body may have a holding element for holding the expansion element. The holding element may be provided to hold the expansion element in the hollow body in a form-fitting and/or force-fitting manner. The holding element in this case may be made of a plastic, a paper, or of another material considered appropriate by persons skilled in the art. The holding element may be realized as a foil. The foil may be provided between the expansion element and the holding element. The foil may furthermore be provided to fix the expansion element in position, in particular on a side opposite the at least one expansion arm, in order to secure the expansion arm against falling out. The holding element may further be provided to reduce a friction force between the hollow body, in particular at least one expansion arm, and at least one expansion element during setting of the plug.

In a further advantageous embodiment, the hollow body may have a groove, in particular a transport groove, which extends in the form of a circle segment along the axis a of the plug. This makes it possible to achieve highly advantageous transport of material, or transport of drilling dust.

In a further embodiment, the plug, in particular the hollow body, may have a fastening region for fastening in a receiving unit and/or in a receiving device of a power tool. This enables the plug, or the hollow body, to be received in a receiving unit and/or receiving device of a power tool. It is particularly advantageous in this case for the plug, or the hollow body, to be received in a receiving unit, in particular realized as an adapter.

Preferably, the fastening region may have at least one recess for, in particular, form-fitting and/or force-fitting connection in a receiving unit and/or receiving device of a power tool. This enables the plug to be coupled to a receiving unit or receiving device. The recess in this case may be realized as an axial and/or radially acting form-fit element. The recess may further be realized as a form-fit element acting in the circumferential direction.

### BRIEF DESCRIPTION OF THE DRAWINGS

Further advantages are given by the description of the drawing. The drawing illustrates exemplary embodiments of the disclosure. The drawing, the description and the claims contain numerous features in combination. Persons skilled in the art will expediently consider the features singly, and combine them for appropriate further combination.

There are shown in:

FIG. 1 a perspective view of a hand-held power tool for drilling a plug into a workpiece,

FIG. 2 a perspective view of the plug,

FIG. 3 a top view of the plug,

FIG. 4 a side view of the plug,

FIG. 5 a perspective view of the plug with a holding element,

FIG. 6 a perspective view of the plug and of a receiving unit,

FIG. 7 a side view of the plug and of a receiving unit, the receiving unit being accommodated in a power tool,

FIGS. 8a-8d respectively, a cross-sectional view of the plug with the receiving unit, in various work steps.

In the figures, components that are the same are denoted by the same references.

### DETAILED DESCRIPTION

The following figures each relate to a plug, in particular for operating with a hand-held power tool, in particular with a receiving device of a hand-held power tool, having a rotatory and/or translatory working motion. A translatory advance motion is imparted to the tool in this case in that the operator of the hand-held power tool applies a force to the hand-held power tool, in particular to the hand-held power-tool housing. The plug according to the disclosure is universal in its application and is suitable, in particular, for performing work on workpieces of wood, plastic, metal, stone or a composite. The plug may be provided to be separably connected to a receiving device, in particular clamping device, that is already known to persons skilled in the art and that is realized to receive a plug, and/or to an additional receiving unit, in particular an adapter, without the necessity of making structural design changes to the receiving device. The plug may additionally be provided to be received in commercially available receiving devices of hand-held power tools that have radially acting clamping jaws.

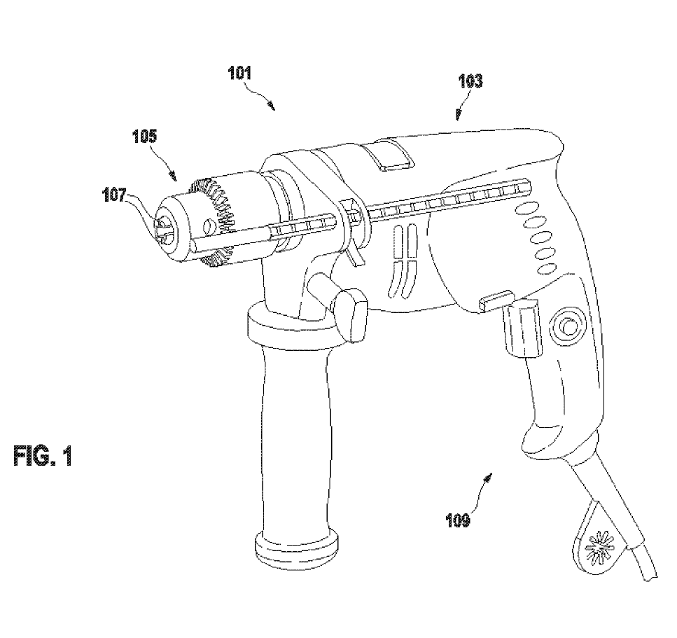

FIG. 1 shows a perspective view of a hand-held power tool 101 for receiving the plug 1 according to the disclosure. The hand-held power tool 101 has a hand-held power-tool housing 103, having at least one grip region 109 to be gripped by at least one hand of a user. In this exemplary embodiment, the receiving devices 105 have three clamping jaws 107, of which only two clamping jaws 107 are shown. The clamping jaws 107 in this case can clamp the plug 1 and/or a receiving unit 61 radially in the receiving device 105.

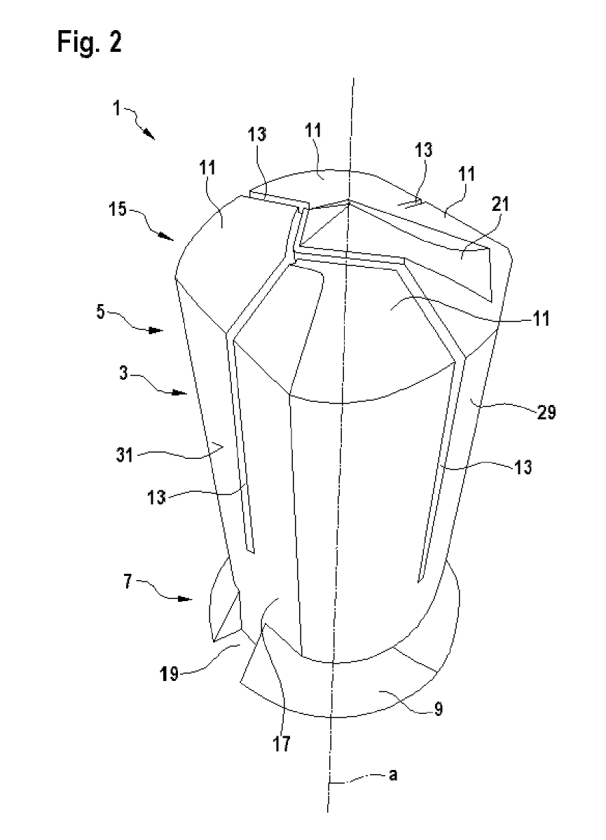

FIG. 2 shows a perspective view of the plug 1. The plug 1 in this case is realized, at least substantially, as a hollow cylinder, and extends along an axis a. The plug 1 has a hollow body 3, which extends along the axis a.

The plug 1 has a working region 5, and has a fastening region 7 that adjoins the working region 5. The fastening region 7 in this case is realized such that it projects radially, at least in portions, in relation to the working region 5. The fastening region 7 may have at least one radial shoulder 9, which at least substantially encompasses the hollow body 3 in the circumferential direction. The shoulder 9 extends against the direction of advance, ascending radially to a circumferential region 31, in particular a circumferential surface 31, of the working region 5, such that a maximum radial extent of the shoulder 9 ensues at a maximum axial extent of the plug 1. The hollow body 3 and the at least one shoulder 9 may be realized as a single piece. In an alternative embodiment, the fastening region 7 may also be realized without a shoulder 9.

The working region 5 has four expansion arms 11, which are disposed around the axis a, and which extend along the axis a, in particular axially. In an alternative embodiment, the working region 5 may have at least one expansion arm 11, such as, for example, two, three, five, six or more expansion arms 11. The expansion arms 11 each have a fixed end, which is adjacent to the fastening region 7, and a free end, which extends substantially axially and transversely, in particular radially, in relation to the axis a. The free end delimits the axial extent of the expansion arms 11, or of the plug 1. The expansion arms 11 thus encapsulate an at least substantially cylindrical volume, which is delimited in the direction of advance by an end face region 15 of the working region 5. Alternatively, the volume may also be realized in the shape of a cone. The expansion arms 11 in the end face region 15 of the working region 5 extend radially in relation to the axis a of the plug 1, and thus constitute a substantially sleeve-type form of the plug 1, in particular of the hollow body 3. The expansion arms 11 in this case each constitute a part of the sleeve-type hollow body 3, and are separated from one another by slots 13. The slots 13 extend along the axis a and separate the respective expansion arms 11 from one another in the circumferential direction.

A cross section of the working region 5 is at least substantially polygonal in form. In particular, the cross section has two round and two flat lateral faces, a round lateral face following a flat lateral face in each case. In addition, the expansion arms 11 also each have a round and a flat lateral face. The cross section has at least one groove 17, such as, for example, two grooves 17, which extends, at least substantially in the form of a circle segment, along the axis a of the plug 1, in particular parallel thereto or, in an alternative embodiment, at least partially helically in relation thereto. In an alternative embodiment, however, the plug may also have at least three, four or more grooves 17. The at least one groove 17 is obtained in that, as viewed in cross section, such as, for example, a circular cross section, a circle segment is recessed to a midpoint. The midpoint in this case may be provided on an axis a of the plug 1. The circle segment comprises a circle arc, which is spanned by two delimiting points, and by a chord connecting the two delimiting points. The chord in this case may be straight or curved.

The at least one groove 17 in this case may be realized as a transport groove for removing fragmented material, or drilling dust, produced during drilling. In an alternative embodiment, at least one groove 17 may extend helically about the axis a of the plug, at least in portions.

The fastening region 7 has at least one recess 19, which is provided to realize a form-fitting connection to at least one receiving unit 61 and/or a receiving device 105 of a hand-held power tool 101. The recess 19 is provided in the shoulder 9, and extends radially as far as the circumferential region 31, in particular the circumferential face 31, of the hollow body. In this embodiment, the recess 19 acts in the circumferential direction. In an alternative embodiment, the recess 19, in particular in a fastening region 7, may be realized in the hollow body 3.

The at least one expansion arm 11 has at least one cutting element 21. In an alternative embodiment, the at least one expansion arm 11 may have at least two cutting elements 21, such as, for example, three, four or more cutting elements 21. In particular, respectively at least one cutting element 21 may be realized on respectively two mutually opposite expansion arms 11. The at least one cutting element 21 projects axially with respect to the hollow body 3, and in the radial direction extends at a greater distance from the circumferential region 31, in particular the circumferential surface 31, of the hollow body 3 than from the axis a. The extent of the cutting element 21 in the radial direction is thus greater than the extent of the hollow body 3 from an axis a to the circumferential region 31, in particular the circumferential surface 31. In an alternative embodiment, the cutting element 21 may extend in such a manner that the cutting element 21 projects in the radial direction in relation to the circumferential region 31, in particular the circumferential surface 31.

The at least one expansion arm 11 and the at least one cutting element 21 are realized as two pieces. In an alternative embodiment, the expansion arm 11 and the cutting element may be realized as a single piece 21. The cutting element 21 in this case may be made of a hard metal or of another material considered appropriate by persons skilled in the art. The expansion arm 11 and/or the cutting element 21, in particular of the single-piece embodiment, may be at least partially hardened. The at least one cutting element 21 may be hardened, for example, by addition of nitrogen and/or carbon, or by other methods considered appropriate by persons skilled in the art.

The cutting element 21 has at least one cutting edge 25 for drilling the material, or the drilled hole.

The cutting edge 25 extends at least substantially in the radial direction along the cutting element 21, and may join an axis a. The cutting edge 25 in this case is realized asymmetrically. The cutting edge 25 may be realized so as to extend at least substantially at right angles to a direction of rotation. The cutting edge 25 may be straight and/or curved.

The cutting element 21 has one centering element 27, which is joined, in particular, by the cutting edge 21. Consequently, the cutting element 21 and the centering element 27 are realized as a single piece, and realized separately from a cutting element 11. Further, the cutting element 21 and the centering element 27 are disposed on at least one expansion arm 11, in particular on an end-face region 15 of the working region 5, and are connected, in particular fixedly, to the latter. In an alternative embodiment, the cutting element 21 and the centering element 27 are realized as two pieces. The at least one expansion arm 11, in particular having the at least one cutting element 21 and/or centering element, is asymmetrical in form, and may be realized, in particular, as a drilling expansion arm 29.

An extent of the drilling expansion arm 29 in the circumferential direction is similar to an extent of adjacent expansion arms 11 of the plug 1. In an alternative embodiment, the extent of the drilling expansion arm 29 in the circumferential direction may be greater than the extent of adjacent expansion arms 11 of the plug 1. The drilling expansion arm 29 extends in the radial direction from a circumferential region 31, in particular a circumferential surface 31, farther than the axis a of the plug 1, such that the extent of the drilling extension arm 29 in the radial direction is greater than the maximum radius of the working region 5 of the hollow body 3.

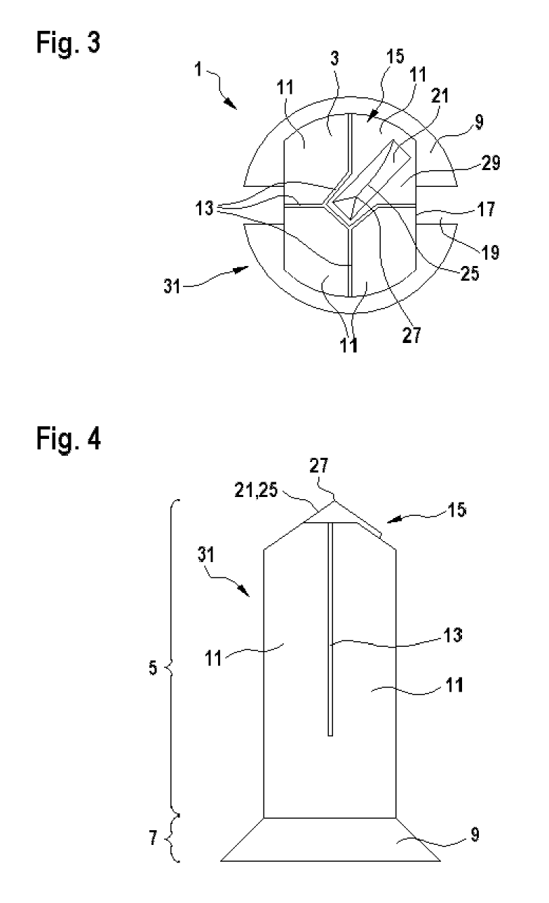

FIG. 3 shows a top view of the plug 1 from FIG. 2. It can be seen how the drilling expansion arm 29 projects, or extends radially, from a circumferential region 31 to beyond the axis a of the plug 1. Additionally shown are the grooves 17, in particular the transport grooves, which extend in the manner of a circle segment along the axis a of the plug 1 and thus realize a transport volume. The recesses 19 are shown as radial incisions in the fastening region 7, in particular in the shoulder 9, of the plug. The recesses 19 in this case are delimited in the radial direction by a circumferential surface 31 realized as a groove surface, in particular of the hollow body 3. In particular, the slots 13, which extend at least substantially axially and separate the expansion arms 23 from one another, are represented.

FIG. 4 shows a side view of the plug 1 according to the disclosure. In this case, the at least one cutting element 21 of the drilling expansion arm 29 projects relative to the expansion arms 11 in the axial direction. In this case, the radial extent of the shoulder 9 increases contrary to the direction of advance. The radial extent of the shoulder 9 may increase abruptly or continuously.

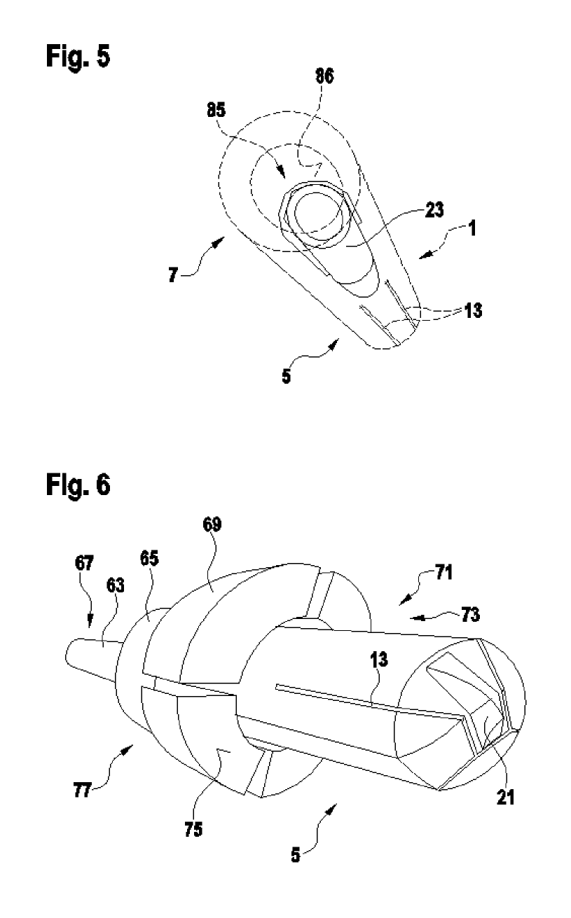

FIG. 5 shows the plug 1 with an expansion element 23 and a holding element 33. The holding element 33 in this case is disposed, at least partially, between the hollow body 3 and the expansion element 23. In particular, the holding element 33 may at least partially encapsulate the expansion element 23. The expansion element 23 is realized, at least substantially, in the form of a cylinder. Alternatively, the expansion element 23 may be realized, at least substantially, in the form of a cone. The holding element 33 is provided to hold the expansion element 23 in the hollow body 3. The holding element 33 in this case may hold the expansion element 23 in the hollow body 3 in a form-fitting and/or force-fitting manner. The hollow body 3 may additionally have an internal region 85 having a thread, in particular an internal thread, which is provided for connection of the plug 1. The internal region 85 of the hollow body 3 is realized, at least substantially, in the form of a cylinder. The internal region 85 may have at least one internal surface 86, which extends at least substantially in the form of a cylinder. Alternatively, the at least one internal surface 86 may be realized at least substantially in the form of a cone.

In particular, the internal region 85 may be subdivided into two portions, which differ from one another in their differing radial extent. A first portion may be provided, at least partially, in the fastening region 7, and adjoin a second portion that is realized in the working region 5. A radial extent of the first portion of the internal region 85 may be greater than a radial extent of the second portion of the internal region 85 and increase continuously or abruptly. The expansion element 23 in this case may be provided in the first portion, in order to displace the expansion arms 11 in the radial direction as the plug 1 is set.

FIG. 6 shows a receiving unit 61, which receives the plug 1. The receiving unit 61 has a shaft 63, which has an insertion region 67, a holding region 65 that is opposite the insertion region 67, and a coupling element 69. The shaft 63 is substantially cylindrical in form and extends along a shaft axis b.

The holding region 65 has at least one form-fit element 71 at an end face 73 that is opposite the insertion region 67. The form-fit element 71 is provided to realize a form-fitting connection, in particular in the circumferential direction, with the fastening region 7, in particular the at least one recess 19, of the plug 1. In an alternative embodiment, the form-fit element 71 may be realized to act axially, such that the plug 1 can be coupled to the holding region 65 in a form-fitting manner and is secured against axial movement. The coupling element 69 encompasses the holding region 65, at least partially, on a circumferential region 77, in particular a circumferential surface.

The coupling element 69 is realized as a hollow cylinder, and may be put over the holding region 65 of the shaft 63, at least partially. The coupling element 69 is provided to align the plug 1, in particular the fastening region 7 of the plug 1, such that the plug 1 is fixed radially in a separable manner in relation to the shaft axis b. On the end face 73, the coupling element 69 has at least one stop face 75. The stop face 75 may be provided to strike against the workpiece, or the wall, when the plug 1 has attained a predefined drilling depth. The coupling element 69 in this case can be displaced axially in relation to the shaft axis b as the drilling depth increases. Optimum guidance of the plug 1 is thereby achieved, from hole tapping to setting of the plug 1. The coupling element 69 in this case may be made of a plastic such as, for example, a rubber or other materials considered appropriate by persons skilled in the art. The coupling element 69 may bear in the radial direction against the circumferential region 77, in particular the circumferential surface, of the holding region 65 in a force-fitting manner, in particular by elastic deformation. In an alternative embodiment, the coupling element 69 may be realized so as to be at least partially integral with the holding region 65.

The insertion region 67 of the shaft 63 is realized to be received in a receiving device 105 of the hand-held power tool 101. The insertion region 67 may have at least one opening 79 (not shown), which is provided to realize a form-fitting connection to the receiving device 105 of the hand-held power tool 101. The at least one opening 79 of the insertion region 67 may be realized so as to correspond to, in particular to be similar to, preferably to match, at least partially, at least one opening 79 of an SDS receiver. The shaft 63 may be realized, at least substantially, as a hollow cylinder, and thus have an inner cavity 81. The cavity 81 may be provided with a striking pin 83, which is provided to strike, or hammer, the expansion element 23 of the plug 1 axially in relation to the shaft axis b.

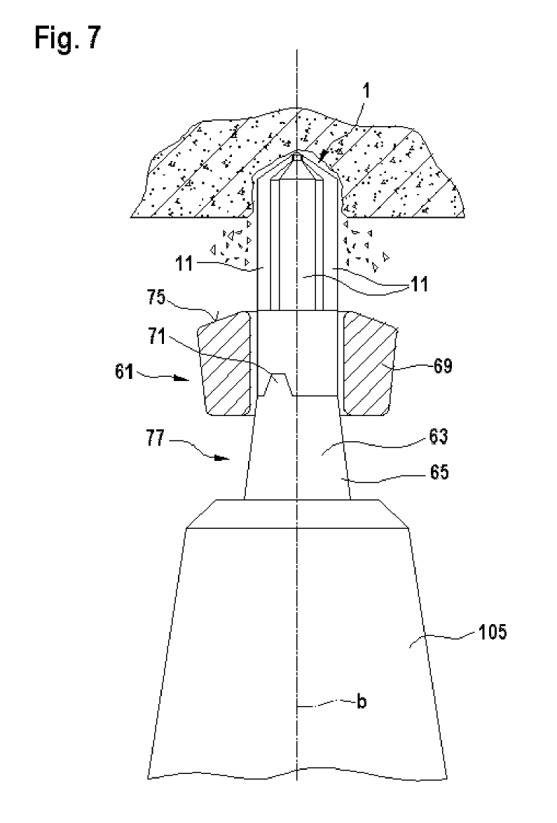

FIG. 7 shows a side view of the receiving unit 61. It can be seen how the at least one form-fit element 71 realizes a form-fitting connection to at least one recess 19 of a further embodiment of the plug 1. The form-fit element 71 in this case is trapezoidal, and extends axially out of the holding region 65 of the shaft 63. The at least one recess 19 of the fastening region 7 of the plug 1 is realized, at least substantially, so as to correspond oppositely to the, in particular trapezoidal, form-fit element 71. However, the geometric shape of the form-fit element 71 is not intended to be limited only to a trapezoidal geometry, but may comprise any geometric shape considered appropriate by persons skilled in the art.

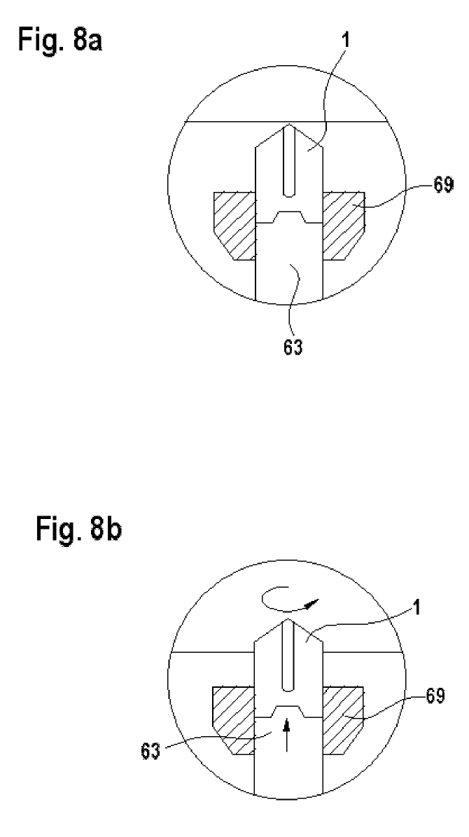

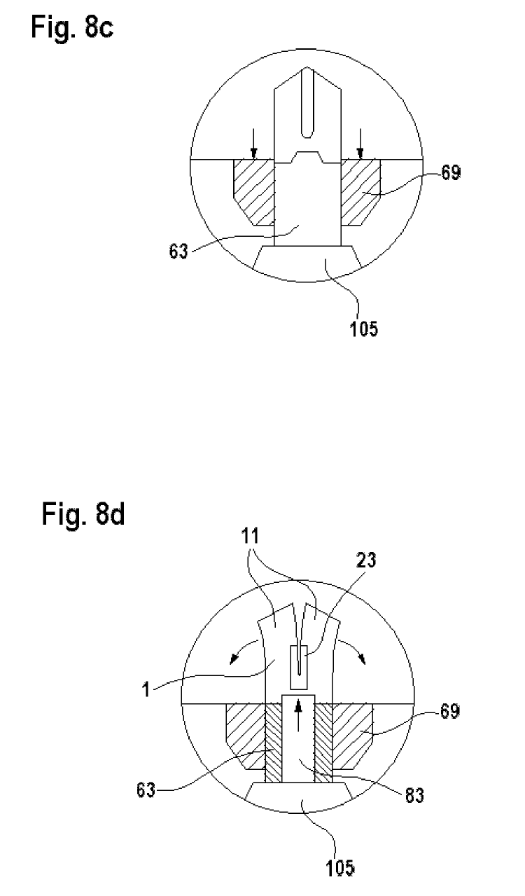

FIG. 8a-8d show a cross-sectional view of the plug with the receiving unit 61 from FIGS. 6-7, in various work steps. FIG. 8a shows a first state, in particular an initial state, of a first work step, which shows the centering of the plug on the workpiece on which work is to be performed. It can be seen in this case that the coupling element 69 encompasses the circumferential region 77 of the shaft 63 and the circumferential region 31 of the plug 1.

FIG. 8b shows a second state of a first work step, in which the plug 1 is drilled, or hammered, into the workpiece, or into the wall. From the first state to the second state, the coupling element 69 is brought into contact with the workpiece, or the wall, and is displaced axially, contrary to the direction of advance, onto the holding region 65 of the shaft 63, as shown in FIG. 8c.

FIG. 8d shows a second work step, which hammers the expansion element 23 in the direction of advance, such that at least one expansion arm 11 is radially deformed and pressed against the drilled hole by the expansion element 23. A force-fitting and/or form-fitting connection, between the expansion arm 11 and the drilled hole, is produced as a result.

What is claimed is:

1. A plug for fastening into a workpiece, comprising:
a hollow body that includes:
at least one expansion arm configured to connect to the workpiece in at least one of a form-fitting and force-fitting fashion; and
an expansion element configured to substantially radially expand the at least one expansion arm; and
at least one cutting element configured to drill into the workpiece.

2. The plug according to claim 1, further comprising:
at least one centering element configured to center the plug.

3. The plug according to claim 1, further comprising:
at least one further expansion arm;
wherein the at least one expansion arm has a maximum radial extent that is different than a maximum radial extent of the at least one further expansion arm.

4. The plug according to claim 3, further comprising:
at least one centering element configured to center the plug;
wherein the at least one centering element and the at least one cutting element are disposed on the at least one expansion arm.

5. The plug according to claim 1, wherein the at least one cutting element includes a hard metal.

6. The plug according to claim 1, wherein the expansion element has a shape at least substantially defined by a cylinder or a cone.

7. The plug according to claim 1, wherein the hollow body includes an integral region that has shape defined by a cylinder or a cone, the integral region extending away from an axis of the plug.

8. The plug according to claim 1, wherein the hollow body further includes:
a holding element configured to hold the expansion element.

9. The plug according to claim 1, wherein the hollow body defines a transport groove that extends as a circle segment along an axis of the plug.

10. The plug according to claim 1, further comprising:
a fastening region configured to fasten into at least one of a receiving unit and a receiving device of a power tool.

11. The plug according to claim 10, wherein the fastening region defines at least one recess that enables at least one of a form-fitting and force-fitting connection in the at least one of a receiving unit and a receiving device of the power tool.

12. The plug according to claim 1, wherein the hollow body is at least substantially defined by a sleeve.

13. The plug according to claim 1, wherein the plug is configured to fasten into a drilled hole of the workpiece.

14. The plug according to claim 1, wherein the plug is configured to fasten into a workpiece that includes at least one of wood, metal, plastic, stone, and composite.
